(19) United States
(12) Patent Application Publication
(10) Pub. No.: US 2008/0317800 A1
(43) Pub. Date: Dec. 25, 2008

(54) Biocidal Composition

(76) Inventor: Djamschid Amirzadeh-Asl, Moers (DE)

Correspondence Address: FULBRIGHT & JAWORSKI, LLP, 666 FIFTH AVE, NEW YORK, NY, 10103-3198, US

(21) Appl. No.: 12/279,071

(22) PCT Filed: Feb. 15, 2007
(86) PCT No.: PCT/EP07/51478

§ 371 Date: Aug. 14, 2008

(30) Foreign Application Priority Data
Feb. 16, 2006 (DE) 102006007515.3

(51) Int. Cl. A01N 25/00; A01N 59/00; A01N 59/02; A01N 59/06; A01N 59/16; A01P 3/00

(52) U.S. Cl. 424/405; 424/600; 424/641; 424/677; 424/617; 424/682; 424/724; 424/715; 424/722; 424/646; 424/125; 977/773

(57) ABSTRACT

The present invention relates to a biocidal composition, a method for its production and the use of the biocidal composition.

The present invention provides a biocidal composition, a process for the preparation thereof and the use of the biocidal composition.

In particular, the present invention relates to a biocidal composition based on zinc sulfide, zinc oxide, barium sulfate, lithopones, titanium dioxide, aluminium oxide, silicon dioxide, calcium carbonate, calcium sulfate and/or zeolites, preferably based on zinc sulfide, zinc oxide, barium sulfate and/or lithopones.

Biocides (from Greek/Latin: killers of life) are active compounds which are used in a large number of products in order to kill, depending on the individual case, a broad spectrum of organisms from viruses, bacteria, algae, fungi and insects up to molluscs and rodents. There are about 8,000 biocide products on the market which eliminate, scare off or decimate small and tiny organisms which are undesirable to humans in certain situations. These include, above all, agents against bacteria, algae and fungi, but also those against spiders, mice, rats, flies or mosquitoes. Typical biocide products are wood preservatives, insect sprays for the home, mould-repellent wall paints for the bathroom or kitchen, antibacterial household cleaning compositions, disinfecting sprays and bait traps against clothes moths. Biocide products largely arrive at the consumer as ready-to-use articles. Thus, textiles with the “Woolmark” quality symbol always have a mothproof finish.

According to their action against various groups of organisms, microbicides (against microorganisms), insecticides (against insects), molluscicides (against molluscs), rodenticides (against rodents) and so on are referred to. The microbicides include the algicides, bactericides, fungicides and virucides.

Algicides are compounds which kill algae or inhibit the growth or multiplication thereof. Paint algicides are homogeneously distributed in paint compositions, so that paint films produced therefrom are permanently protected against growth of algae, even under adverse conditions, such as the action of rain and light. It follows that paint algicides are practically insoluble in water and are stable to light. It is also expected that paint algicides do not discolour the paint film, are not volatile, are not very toxic and are compatible with other components of the paint composition. Examples of paint algicides are chlorthalonil, diuron and dichlofluanid.

Fungicides are microbicides which kill fungi and spores thereof. They are employed, inter alia, in wood preservation against blue stain (wood-discolouring fungi) and wood-destroying fungi, but also in order to prevent the growth of harmful fungi on foodstuffs, textiles, walls, paper, wood, size, paints, lubricants and even fuels etc.

Antifouling paint films are paint films which are applied in the underwater region of ships, drilling towers etc. and have an inhibiting action on growth there. A characteristic of antifouling paint films is the content of compounds having an algicidal and fungicidal action, conventionally copper oxide and organotin compounds, the tin organyls in particular being ecologically unacceptable.

In uses such as, for example, lacquers, paints, plastics, medical products etc., metal ions are employed as biocides, in particular as microbicides, in particular in the form of compositions based on metal salts. The metal ions are, in particular, heavy metals ions, for example copper, silver, tin and nickel ions.

For the treatment of water, the prior art proposes, for example, water-soluble inorganic metal salts, such as copper sulfate, copper nitrate and copper chloride, for use as algicides or bactericides for the treatment. However, the use of copper or sources of copper ions has the disadvantage, inter alia, that in alkaline or almost alkaline media copper ions react with naturally occurring anions and precipitate out as insoluble salts, for example as carbonates, oxides or hydroxides. This pH-dependent precipitation leads to losses of biocidal activity, since copper ions are then no longer available.

Copper salt biocides moreover are more active against algae than against bacteria and other pathogens. In order therefore to achieve a significant biocidal activity of copper salts against bacteria, higher copper concentrations are necessary, which is not desirable. If bacteria or other pathogens are also to be active with algicides containing copper salts, this in general requires the use of additional biocides.

The prior art likewise discloses the preparation and use of microbicidal compositions in inorganic carriers, such as, for example, the oxides of titanium, magnesium, aluminium or silicon, of barium sulfate and of zeolites, in particular for use in polymers (U.S. Pat. No. 4,525,410, U.S. Pat. No. 4,775,585, U.S. Pat. No. 4,906,466).

EP-B-1463411 discloses the use of zinc sulfide as an agent against mites. In this context, zinc sulfide is employed in formulations for sizing threads, fibres and filaments and in a liquid or solid composition for cleaning or treatment of textile surfaces.

However, the prior art discloses no technical teaching which renders it possible to provide a biocidal composition which acts as an algicide and/or fungicide and/or antibacterially, as required, in various uses by combination of inorganic solids and biocidally acting substances.

The prior art also discloses no technical teaching which eliminates the problem that certain inorganic solids, for example pigments, such as zinc oxide, zinc sulfide, titanium dioxide and lithopones, have only a very retarded activity against algae and-bacteria and/or other pathogens. Zinc oxide, zinc sulfide, titanium dioxide and lithopones moreover are in principle more active against algae than against bacteria and other pathogens. To achieve a significant biocidal activity, according to the prior art it is necessary to employ high concentrations, which is not desirable. Barium sulfate is even completely inert, that is to say it shows no biocidal activity at all, even in high concentrations.

The object of the present invention is to overcome the disadvantages of the prior art.

An object of the invention in particular is to provide a biocidal composition which, depending on the use and requirement, acts as an algicide and/or fungicide and/or antibacterially.

A further object of the present invention is to provide a biocidal composition which acts both against algae and against fungi as well as against bacteria.

According to a further object of the invention, it should be possible to employ this composition in various uses, such as lacquers and paints, for example water colours or water-based paints, coatings, rendering or coats of plaster, glazes, impregnations, semi-thick coatings, plastics and medical objects.

According to a further object of the invention, the biocidal composition should comprise inorganic solids, preferably pigments, fillers and/or nanoscale particles, nanoscale particles being understood as meaning those of which the average particle size is below 250 nm.

According to a further object of the invention, the inorganic solids employed should preferably have biocidal properties themselves.

According to a further object of the invention, the pigment or filler properties of the inorganic solids should be retained.

A further object of the invention is to provide a novel coating composition which has a biocidal action in the end use.

According to a further object of the invention, the novel coating composition should have a higher, immediate and long-lasting activity against algae, fungi and/or bacteria. This coating composition should moreover be usable as an antifouling paint film, and prevent the growth of marine organisms, such as algae, shellfish, crustaceans etc., on ships and other marine vehicles, apparatuses and devices.

Surprisingly, the objects have been achieved by the features of the main claim. Preferred embodiments are to be found in the sub-claims.

In particular, it has been found, surprisingly, that the abovementioned objects are achieved by inorganic solids which have been surface-modified with one or more biocidally acting substances, in particular metal salt compounds.

All compounds which can be used as a pigment or fillers can be employed as the inorganic solid, for example zinc sulfide, zinc oxide, barium sulfate, barite, mica, talc, kaolin, lithopones, titanium dioxide, aluminium oxide, silicon dioxide, calcium carbonate, calcium sulfate, zeolites, iron oxide, magnesium hydroxide, aluminium hydroxide and carbon, in particular graphite. The solid can be of either natural or synthetic origin.

Metal salts which have a biocidal property are preferably employed for the surface modification. In this context, inorganic or organic substances, individually or in a mixture, can be used as metal salts. The compounds or salts of metals, for example of zinc, copper, silver and/or tin, preferably of zinc, can be used as the starting material for the surface modification of the inorganic solids.

All soluble or sparingly soluble salts of biocidally acting metals, individually or in a mixture, can in principle be used for surface modification of inorganic solids.

The amount of metal salts added is, based on the weight of the inorganic solid, 0.01 to 50 wt. %, preferably 0.1 to 30 wt. %, particularly preferably 0.5 to 20 wt. %.

The average particle size of the inorganic solids, if they are nanoscale particles, is between 200 and 1 nm, preferably between 120 and 2 nm, particularly preferably between 100 and 4 nm, very particularly preferably between 80 and 5 nm.

The average particle size of the inorganic solids, if they are not nanoscale particles, is between 0.25 and 500 μm, preferably between 0.3 and 200 μm, particularly preferably between 0.3 and 30 μm.

In this context, the particles can have various forms, for example a platelet, needle, spherical or epitactic form.

Substances which themselves have a biocidal property, for example are algicidal and/or microbicidal, are preferably used as inorganic solids. In particular, zinc oxide, zinc sulfide, titanium dioxide and/or lithopones are used for the preparation of the biocidal composition according to the invention.

Barium sulfate can furthermore also be employed according to the invention.

Metal salts which are preferably employed are zinc salts, for example zinc sulfate (hepta- and/or monohydrate), zinc chloride, zinc nitrate, zinc bromite, zinc iodite, zinc borate, zinc fluoride, zinc acetate, zinc citrate, zinc acetylacetonate, zinc formate, zinc lactate, zinc oxalate, zinc salicylate, zinc laurate, zinc valerate, zinc stearate, zinc phosphate or mixtures of at least two of these substances.

Organic zinc salts, for example zinc acetate, zinc citrate, zinc acetylacetonate, zinc formate, zinc salicylate, zinc benzoate or mixtures of at least two of these substances are particularly preferably employed. Zinc acetate, zinc citrate, zinc oxalate or mixtures of at least two of these substances are particularly preferably employed.

The composition can be prepared by processes known per se, for example by mixing the constituents according to the invention. In this context, the surfaces of the inorganic solids can preferably be modified.

All possible variants which correspond to the prior art and are known can be used in the surface modification of the inorganic solids by the corresponding metal salts. For example, the surface modification can be carried out during the precipitation of the inorganic solids, during the treatment of the inorganic solids in suspension before the drying or also before or after the grinding.

The finely divided inorganic solids are preferably in the form of an aqueous suspension or of a filter-cake (paste-like or as a dough). It is advantageous to employ a filter-cake in the non-dried state, for example from running production.

Drying of the suspension provided with the metal salts or of the filter-cake provided with the metal salts can be carried out by means of conventional drying units. Spray dryers, grinding dryers or vacuum dryers are preferably used.

In the case of surface treatment of the inorganic solids after the drying, the biocidally acting compounds can be added in liquid form or in powder form. For homogenizing the mixture, the conventional mixing units, for example plough-share mixers or drum mixers, can be used. Depending on the compound employed, a heat treatment can be carried out before, during and after the mixing. If necessary, a subsequent grinding can be carried out. In this case, the mixtures are preferably subjected to a vapour jet, air jet or pinned disc grinding.

Another possibility of modifying metal salts on the surface of the inorganic solids is direct treatment of the inorganic solids with the corresponding acid. In this context, for example, the desired zinc salts are formed by treatment of zinc sulfide, zinc oxide, zinc sulfide, titanium dioxide, barium sulfate and/or lithopones with corresponding acids, such as sulfuric acid, nitric acid, hydrofluoric acid, hydrochloric acid, bromic acid, iodic acid, boric acid, phosphoric acid, peroctanoic acid, glycolic acid, oxalic acid, lactic acid, citric acid, benzoic acid or salicylic acid, or with acetylacetone or a fatty acid. In this context, the acids can be employed individually or in a mixture.

All possible procedures which are known can be employed for the surface treatment of the inorganic solids with acids. In this context, the treatment can be carried out during the precipitation, before the drying, after the drying, before the grinding or also after the grinding.

The amount of acids added is controlled so that the amount of metal salts formed, based on the weight of the inorganic solid, is 0.01 to 50 wt. %, preferably 0.1 to 30 wt. %, particularly preferably 0.5 to 20 wt. %.

The biocidally acting composition according to the invention can be in the form of a powder, paste, suspension or slurry, depending on the field of use.

The present invention provides, in detail:
a biocidal composition which comprises inorganic solids, wherein the inorganic solids are pigments and/or fillers, wherein
   the inorganic solids are zinc sulfide, zinc oxide, barium sulfate, barite, mica, talc, kaolin, lithopones, titanium dioxide, aluminium oxide, silicon dioxide, calcium carbonate, calcium sulfate, zeolites, iron oxide, magnesium hydroxide, aluminium hydroxide, carbon, in particular graphite, or mixtures of at least two of these substances;
   the inorganic solids are in the form of nanoscale and/or non-nanoscale particles,
   the average particle diameter of the inorganic solids, if they are nanoscale particles, is between 200 and 1 nm, preferably between 120 and 2 nm, particularly preferably between 100 and 4 nm, very particularly preferably between 80 and 5 nm,
   the average particle diameter of the inorganic solids, if they are not nanoscale particles, is between 0.25 and 500 μm, preferably between 0.3 and 200 μm, particularly preferably between 0.3 and 30 μm,
   the inorganic solids are in a platelet, needle, spherical and/or epitactic form,
   and/or the surface of the inorganic solids is modified, preferably with a metal salt, wherein
      the metal salt is a salt of zinc, of copper, of silver or of tin or mixtures of at least two of these metal salts,
      the metal salt is a metal salt of sulfuric acid, nitric acid, hydrofluoric acid, hydrochloric acid, bromic acid, iodic acid, boric acid, phosphoric acid, peroctanoic acid, glycolic acid, oxalic acid, lactic acid, citric acid, benzoic acid, salicylic acid, of acetylacetone or of a fatty acid, or a mixture of at least two of the salts of these acids, where a C₁- to C₁₈-fatty acid, preferably formic acid, acetic acid, propionic acid, butyric acid, valeric acid, capric acid, lauric acid, stearic acid or a mixture of at least two of these acids is preferred as the fatty acid,
      the metal salt is preferably a metal salt of acetic acid, of oxalic acid or of citric acid,
      the metal salt is a zinc salt, preferably chosen from the inorganic zinc salts zinc sulfate, preferably zinc sulfate heptahydrate or zinc sulfate monohydrate, zinc nitrate, zinc fluoride, zinc chloride, zinc bromide, zinc iodide and zinc borate, and/or the organic zinc salts zinc formate, zinc acetate, zinc valerate, zinc laurate, zinc stearate, zinc phosphate, zinc oxalate, zinc lactate, zinc citrate, zinc salicylate, zinc benzoate and zinc acetylacetonate, or mixtures of at least two of these salts, particularly preferably chosen from zinc acetate, zinc oxalate, zinc citrate or mixtures of at least two of these metal salts.
      and/or the content of the metal salt, based on the weight of the inorganic solid, is 0.01 to 50 wt. %, preferably 0.1 to 30 wt. %, particularly preferably 0.5 to 20 wt. %;
a biocidal composition as described above, which is in the form of a powder, paste, suspension or slurry;
a biocidal composition as described above, wherein the inorganic solids have algicidal, fungicidal and/or antibacterial properties;
a biocidal composition as described above, wherein the metal salt has algicidal, fungicidal and/or microbicidal properties;
a biocidal composition as described above, wherein this has a high, immediate and long-lasting activity against algae, fungi and/or bacteria.

The invention furthermore provides
a process for the preparation of a biocidal composition as described above, in which . . . and the surface of the inorganic solids is modified during and/or after precipitation thereof, wherein
   the surface of the inorganic solids is modified before, during and/or after the drying,
   the surface of the inorganic solids is modified before, during and/or after the grinding,
   and/or the surface of the inorganic solids is modified by treatment with an acid, wherein
      the acid is sulfuric acid, nitric acid, hydrofluoric acid, hydrochloric acid, bromic acid, iodic acid, boric acid, phosphoric acid, peroctanoic acid, glycolic acid, oxalic acid, lactic acid, citric acid, benzoic acid, salicylic acid, acetylacetone, a fatty acid or a mixture of at least two of these acids, where a C₁- to C₁₈-fatty acid, preferably formic acid, acetic acid, propionic acid, butyric acid, valeric acid, capric acid, lauric acid, stearic acid or a mixture of at least two of these acids is preferred as the fatty acid,
      and/or the acid is acetic acid, oxalic acid or citric acid.

The invention furthermore provides
the use of a biocidal composition as described above as an algicide, fungicide and/or microbicide;
the use of a biocidal composition as described above for inhibition of the growth of marine organisms, such as algae, shellfish and crustaceans, on ships and other marine vehicles, apparatuses and devices;
the use of a biocidal composition as described above as a pigment and/or filler;
the use of a biocidal composition as described above for the preparation of and/or for use in lacquers, paints, preferably water colours and/or water-based paints, glazes, impregnations, coatings, plasters, plastics and/or medical materials and apparatuses.

1-26. (canceled)

27. A biocidal composition comprising an inorganic solid, wherein the inorganic solid comprises at least one of a pigment or a filler.

28. A composition according to claim 27, wherein the inorganic solid comprises at least one of zinc sulfide, zinc oxide, barium sulfate, barite, mica, talc, kaolin, lithopones, titanium dioxide, aluminium oxide, silicon dioxide, calcium carbonate, calcium sulfate, zeolites, iron oxide, magnesium hydroxide, aluminium hydroxide or carbon.

29. A composition according to claim 27, wherein the inorganic solid comprises graphite.

30. A composition according to claim 27, wherein the inorganic solid is in the form of nanoscale or non-nanoscale particles.

31. A composition according to claim 27, wherein an average particle diameter of the inorganic solid is between 200 and 1 nm.

32. A composition according to claim 27, wherein an average particle diameter of the inorganic solid is between 0.25 and 500 μm.

33. A composition according to claim 27, wherein the inorganic solid is in platelet, needle, spherical or epitactic form.

34. A composition according to claim 27, wherein the surface of the inorganic solid is modified with a metal salt.

35. A composition according to claim 34, wherein the metal salt is a salt of zinc, of copper, of silver or of tin, or mixtures of at least two of these metal salts.

36. A composition according to claim 34, wherein the metal salt is a metal salt of sulfuric acid, nitric acid, hydrofluoric acid, hydrochloric acid, bromic acid, iodic acid, boric acid, phosphoric acid, peroctanoic acid, glycolic acid, oxalic acid, lactic acid, citric acid, benzoic acid, salicylic acid, of acetylacetone or of a fatty acid.

37. A composition according to claim 34, wherein the metal salt is a metal salt of formic acid, acetic acid, propionic acid, butyric acid, valeric acid, capric acid, lauric acid or stearic acid.

38. A composition according to claim 34, wherein the metal salt is a metal salt of acetic acid, oxalic acid or citric acid.

39. A composition according to claim 34, wherein the metal salt is a zinc salt.

40. A composition according to claim 39, m wherein the zinc salt is zinc sulfate heptahydrate, zinc sulfate monohydrate, zinc nitrate, zinc fluoride, zinc chloride, zinc bromide, zinc iodide, zinc borate, zinc formate, zinc acetate, zinc valerate, zinc laurate, zinc stearate, zinc phosphate, zinc oxalate, zinc lactate, zinc citrate, zinc salicylate, zinc benzoate or zinc acetylacetonate.

41. A composition according to claim 34, wherein, the content of the metal salt is 0.01 to 50 wt. % based on the weight of the inorganic solid.

42. A composition according to claim 27 in the form of a powder, paste, suspension or slurry.

43. A composition according to claim 27, wherein the inorganic solid have at least one of an algicidal, fungicidal or antibacterial property.

44. A composition according to claim 34, wherein the metal salt has at least one of an algicidal, fungicidal or microbicidal property.

45. A composition according to claim 27 having a high, immediate and long-lasting activity against at least one of algae, fungi or bacteria.

46. A process for the preparation of a composition according to at least one of claim 27, comprising mixing at least two inorganic solids and modifying the surface of the inorganic solid.

47. A process according to claim 46, wherein the surface of the inorganic solids is modified before, during or after the drying.

48. A process according to claim 46, wherein the surface of the inorganic solid is modified before, during or after grinding.

49. A process according to claim 27, wherein the surface of the inorganic solids is modified by treatment with an acid.

50. A process according to claim 49, wherein the acid is sulfuric acid, nitric acid, hydrofluoric acid, hydrochloric acid, bromic acid, iodic acid, boric acid, phosphoric acid, peroctanoic acid, glycolic acid, oxalic acid, lactic acid, citric acid, benzoic acid, salicylic acid, acetylacetone, a fatty acid or a mixture of at least two of these acids.

51. A process according to claim 49, wherein the acid is acetic acid, oxalic acid or citric acid.

52. A method comprising applying an effective amount of the composition of claim 27 to an area be effective as an algicide, fungicide or microbicide to the area.

53. A method comprising applying an effective amount of the composition according to claim 27 to inhibit growth of marine organisms on a ship, a marine vehicle, a marine apparatus or a marine device.

54. A composition of matter comprising a pigment and/or filler, wherein the pigment or filler is the composition of claim 27.

55. A lacquer, paint, glaze, impregnation, coating, plaster, plastic medical material or apparatuses comprising the composition of claim 27.
